(19) United States
(12) Patent Application Publication
(10) Pub. No.: US 2004/0111754 A1
(43) Pub. Date: Jun. 10, 2004

(54) System and method for delivering media content

(76) Inventors: Robert R. Bushey, Cedar Park, TX (US); Benjamin A. Knott, Round Rock, TX (US); William L. Reber, Rolling Meadwos, IL (US)

Correspondence Address: GENERAL NUMBER 00757, BRINKS HOFER GILSON & LIONE, P.O. BOX 10395, CHICAGO, IL, 60611, US

(21) Appl. No.: 10/313,995

(22) Filed: Dec. 5, 2002

(51) Int. Cl. H04N 7/173; H04N 7/16

(52) U.S. Cl. 725/115; 725/116; 725/145; 725/146; 725/87

(57) ABSTRACT

A television program is stored in a digital storage format for downloading to end viewers. The television program is made inactive for downloading in a first blackout period associated with its first broadcast on a broadcast television network. The television program is made inactive for downloading in a second blackout period associated with its second broadcast. The television program is made active for downloading in a first active period between the first blackout period and the second blackout period

### CROSS-REFERENCE TO RELATED APPLICATIONS

The present application is related to, and incorporates by reference, the following applications having the same assignee as the present application:

“DSL VIDEO SERVICE WITH MEMORY MANAGER”, filed on the same day as the present application, having application Ser. No. __/___,___ (dkt. # 8285/561);

“DSL VIDEO SERVICE WITH AUTOMATIC PROGRAM SELECTOR”, filed on the same day as the present application, having application Ser. No. __/___,___ (dkt. # 8285/564);

“DSL VIDEO SERVICE WITH STORAGE”, filed on the same day as the present application, having application Ser. No. __/___,___ (dkt. # 8285/565); and

“SYSTEM AND METHOD FOR SEARCH, SELECTION AND DELIVERY OF MEDIA CONTENT”, filed on the same day as the present application, having application Ser. No. __/___,___ (dkt. # 8285/562).

### BACKGROUND OF THE INVENTION

1. Field of the Invention

The present invention relates to video distribution systems.

2. Description of the Related Art

Some individuals subscribe to a service that uses a digital video recorder (DVR) at a subscriber location in conjunction with an electronic program guide to record broadcast programs. Examples of the DVRs include those sold under the brand names of TIVO® and REPLAYTV®.

Some subscribers use their DVRs as a means to eliminate commercials from their viewing experience. For example, consider a viewer who records a 30-minute program using his/her DVR. After about 10 minutes of recording the 30-minute program, the viewer may begin to playback the program while simultaneously recording the remainder of the program. During playback, the viewer can advance through or otherwise skip any commercials in the program, and finish watching the program within a few minutes of the end of the broadcast. Allowing users to eliminate commercials from their viewing experience disrupts an economic model associated with broadcast television advertising.

DVRs are used to record broadcast television programs which adhere to a structured schedule. For example, consider television programs which are initially broadcast in prime time on over-the-air local affiliates of a broadcast network (e.g. ABC, CBS, NBC, FOX, UPN or WB). Some of these television programs (e.g. “24” or “Monk”) have an encore broadcast on a cable television network (e.g. FOX or USA) within a week after the initial broadcast. After the initial broadcast and the encore broadcast, the television program may have a rerun broadcast on the broadcast network. Thereafter, the television program may be syndicated for re-broadcast on over-the-air local stations (e.g. WABC, WBBM, KNBC) or on a cable television channel (e.g. TVLand). Viewers' opportunities to record the television program using the DVRs are limited to the above schedule.

U.S. Patent Application Publication No. 2001/0042249 discloses show requests that can occur in one of at least two ways. First, a user can directly request a show, such as browsing through a directory and selecting a show to request from the server. In a second method, a user can subscribe to a particular show, series of episodes, or genre of entertainment, for example. As episodes included in a subscription become available at the server-side, they are automatically delivered to the client using the client's idle bandwidth.

U.S. Pat. No. 6,353,444 discloses an auxiliary menu item that provides a preset for recording of next episode in a series.

U.S. Patent Application Publication No. 2002/0040475 discloses an electronic programming guide having enhanced functionality which includes the ability to track previously selected content so that identical or similar programs can be recorded in the future.

U.S. Patent Application Publication No. 2002/0038358 discloses a module designed to accommodate a request to add a single show. The module is used to add record events as specified after checking for conflicts or free disk space availability. Exemplary data that can be helpful in creating a data structure to be used by the module include an indicator to record all episodes and an indicator of the number of episodes.

U.S. Patent Application Publication 2002/0124249 discloses having advertisements downloaded to a set-top box. The advertisements are merged with content either dynamically during playback or by modification to the stored content to insert new advertisements.

U.S. Patent Application Publication 2002/0129375 discloses having data pre-loaded onto a set-top box. For example, short pre-loaded video clips such as movie trailers or advertisements may be displayed prior to showing a selected video. To increase the probability that a viewer will watch the trailers and advertisements, the pre-loaded trailer clips can be selected based on a subscriber's profile.

U.S. Patent Application Publication No. 2002/0052782 discloses rewarding users for viewing advertisements and for providing information about themselves. This facilitates selection and targeting of advertisements, and allows video channel viewers to subsidize and pay for the video channel programs that they are watching and the interactive video service they are using. An incentive might comprise a rate at which the buyer entity is compensated for viewing and/or interacting with advertisements. Additionally, or alternatively, it might comprise rewards that are promised to the buyer entity for responding in certain ways to these advertisements.

U.S. Patent Application Publication No. 2002/0059584 discloses content providers (broadcasters and advertisers) using usage history information to develop various content access, billing, and compensation models for consumers and content creators/owners.

U.S. Pat. No. 6,400,996 discloses interactive television advertising models wherein a user may control the content and/or commercial information received. In some cases, certain commercial sponsors may be able to avoid deletion of their advertisement, while others may allow truncation. The acceptability of this to the consumer may depend on subsidies. Instead of paying for placements directly to the media, a portion is paid to a service provider, based on consumer viewing. The media, on the other hand, may seek to adopt a pay-per-view policy, at least with respect to the service provider, in lieu of direct advertising revenues. The service provider will account to both advertisers and content providers for use. With sufficient viewing of commercials, the entire service charge for a system might be covered for a user. On the other hand, a viewer might prefer to avoid all commercials, and not get the benefit of a subsidy. In this case, the recipient may be denied a subsidy from the commercial advertiser, and pay for the privilege of commercial free content.

The service provider performs the function of delivering optimized, substituted commercials for the general commercials provided by the commercial broadcast networks, and thus can accrue profits after paying content providers a fee. An advertiser, by selecting a particular audience, may pay less than it would otherwise pay to a broadcaster. The content providers may also charge more for the privilege of use of their works.

U.S. Patent Application Publication No. 2001/0056350 discloses recognizing spoken commands from a cable subscriber to control the delivery of entertainment and information services, such as video-on-demand, pay-per-view, channel control, on-line shopping, and the Internet. The speech command which originates at the user site, such as the home of the subscriber, is sent upstream via the return path in the cable system to a central speech recognition and identification engine.

The determination of an associated user site may be provided by an identification within the speech channel. For example, a technician may be recognizable at many user sites, and may identify the user site as Room 432 or 10 Main Street in the process of activities at that user site.

A given residence may include more than one set-top box, each of which having a distinct address in the network delivering video content and/or cable television. Each constitutes a distinct user site and may be parameterized differently. For example, a first set-top box in a recreation area for children may allow identified users, who are children, to select programming on only certain channels. A second set-top box in a private area of adults, such as a parental bedroom, may be parameterized so that child identifier users have no privileges.

U.S. Pat. No. 6,005,861 discloses a system in which a user may choose to watch a movie from a video-on-demand service by making a selection on a hand-held remote control. A microprocessor is responsive to the selection to change the positions of switches to establish a direct circuit between a network interface unit that is connected to an external network that carries the video-on-demand service, and set-top electronics that is coupled to a television receiver on which the user desires to view the movie. With this direct circuit, data entering the home through the network interface unit is provided directly to the set-top electronics at the location where the data will be used.

U.S. Pat. No. 5,878,141 discloses an interactive television system for facilitating electronic purchases of goods and/or services. The interactive television system includes a centralized head end server which is configured to provide both television programming services and financial transaction services to multiple homes. A single head end server might be designed, for example, to service 250,000 homes. Each home may have at least set-top box coupled to at least one television, and a remote control handset. The set-top boxes are connected to receive signals from the head end server, and to control which programs are displayed on their associated televisions.

U.S. Pat. No. 6,167,443 discloses a remote video delivery system which transmits video and text from a hotel office to hotel rooms. The system relies on an identification code stored by a telephone accessory to locate a particular room in which to send information or entertainment.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of a system for providing a downloading service;

FIG. 2 is a flow chart of an embodiment of a method of making a television program or another media content item active and inactive for downloading;

FIG. 3 illustrates a time period during which the television program is initially broadcast;

FIG. 4 illustrates a time period of the encore broadcast of the television program;

FIG. 5 illustrates a time period of the rerun broadcast of the television program; and

FIG. 6 is a flow chart of an embodiment of a method of downloading the television program.

### DETAILED DESCRIPTION OF THE PREFERRED EMBODIMENTS

Disclosed herein are embodiments of a method and system for providing a media content delivery service in which subscribers have greater control over media content, advertising, preferences and other actions. Subscribers can order media content, such as television programs, movies or music, and decide when and where they want to view them. In addition, economic problems posed by some view-on-demand systems are addressed by introducing embedded, targeted and contextual advertising.

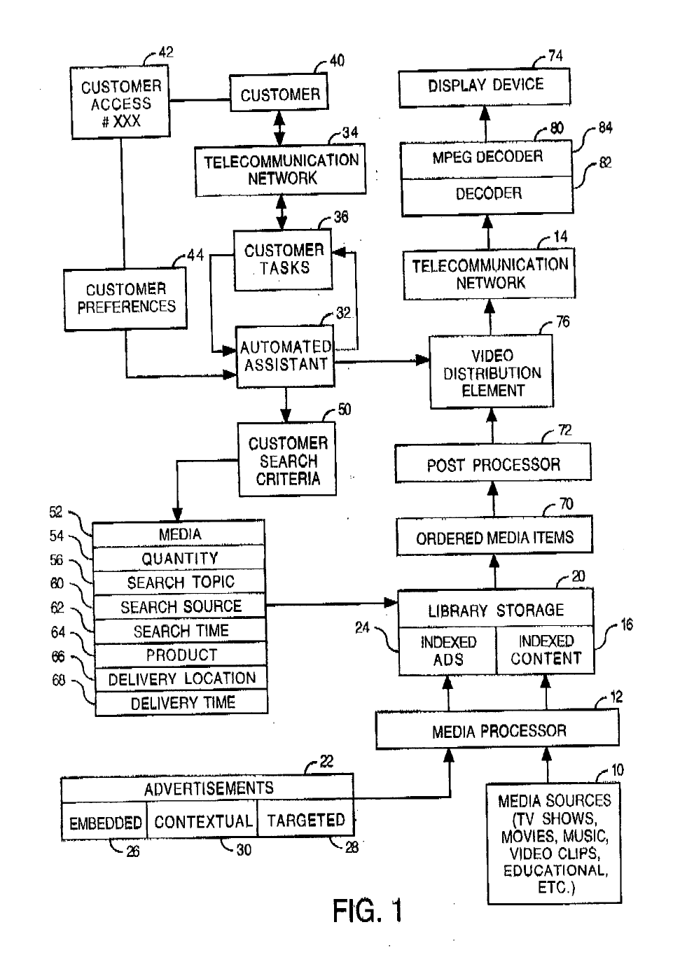

FIG. 1 is a block diagram of a system for providing a downloading service. The downloading service provides subscribers access to various media content from multiple media sources 10. Examples of the media sources 10 include, but are not limited to, television programs from broadcast television channels, programs from broadcast audio channels, sports programs, old movies, new movies, music, video clips, and educational videos. In general, the media content includes video content and/or audio content.

The media content from the media sources 10 is processed by a processor 12 into a form conducive for searching, communicating via a telecommunication network 14, and selectively including advertising. In one embodiment, the processor 12 acts to reformat the media content into a digital format such as Motion Pictures Experts Group 2 (MPEG2) or another MPEG format, to include indexing to facilitate searching for particular media content items, and to perform advertising processing. The result is indexed content 16 stored in library storage 20. The library storage 20 comprises mass storage device(s) and storage media to store a library of media content and advertising.

The processor 12 also processes advertisements 22 (i.e. commercials) from advertisers. In one embodiment, the processor 12 acts to reformat the advertisements 22 into a digital format such as MPEG2 or another MPEG format, and to include indexing to facilitate searching for particular advertisement items. The result is indexed advertisements 24 stored in the library storage 20.

The advertisements 22 include embedded advertisements 26, targeted advertisements 28 and contextual advertisements 30. The embedded advertisements 26 are advertisements as they appear with broadcasts of television and radio programs. Subscribers can choose to include embedded advertising or they can pay a higher rate for advertisement-free programming.

The targeted advertisements 28 are advertisements that meet an immediate information need of a subscriber. For example, if a subscriber is in a process of shopping for a car, he/she can request to see only car advertisements with his/her ordered program. Since media content and advertisements are stored separately, the subscriber can also request to see commercials without a television program. Advertisers may pay more for the targeted advertisements 28 than for the embedded advertisements 26 (with all other factors being equal).

The contextual advertisements 30 are advertisements that make sales offerings based on specific information about the subscriber. For example, if a subscriber orders a baseball game through the downloading service, the service may advertise pizza delivery. If the subscriber orders a documentary on World War II, the service may advertise for books on the topic of World War II. Again, advertisers may pay more for contextual advertisements 30 than for embedded advertisements 26 (with all other factors being equal).

The downloading service may receive revenue from customers and/or advertisers based on whether no advertising, embedded advertising, targeted advertising, or contextual advertising is displayed to the customers. These advertising options re-establish the value of commercials for advertisers and program development while enhancing the subscriber's control over media content delivery.

An automated assistant 32 provides, via a telecommunication network 34, a user interface for the downloading service. The automated assistant 32 provides a flexible and controllable environment for subscribers to request any of a variety of tasks 36 be performed. Examples of the tasks 36 include, but are not limited to: searching for and selecting movies, recorded television programs, music, and other media content; scheduling the download of the selected media content; scheduling for the viewing of more than one program; saving favorite content information; saving an identifier of programs in a series that have already been viewed by the subscriber; customizing a program guide; and configuring an appropriate viewing device.

The automated assistant 32 may comprise an interactive voice response unit (VRU) which allows customers to place orders using telephony devices (e.g. landline or wireless telephones) via a telephone network. In this case, customers can enter orders using either their voices or dual-tone multiple frequency (DTMF) signals generated by their telephone keypads. Optionally, the downloading service may use a human assistant to interact with customers.

Either as an alternative to or in addition to the VRU, the automated assistant 32 may comprise a computer server which allows customers to place orders using a computing device (e.g. an Internet personal computer or a wireless Internet device) via a computer network. In this case, customers can enter orders using computing devices which are connected to the computer network. Examples of the computer network include, but are not limited to, an Internet, a local area network, a digital subscriber line (DSL) network, and a cable television computer network. In one embodiment, customers are able to interact with a visual interface over an Internet via a Web page or a specialized software application.

For purposes of illustration and example, the description of the downloading service is illustrated with reference to a customer 40. The customer 40 places an order for media content, which is received by the automated assistant 36. The automated assistant 36 obtains a customer access code 42 associated with the customer 40 to facilitate creation, processing, and billing the order.

Associated with the customer access code 42 is a set of customer preferences 44 specific to the customer 40. The customer preferences 44 are categorized and stored by the downloading service. Examples of the customer preferences 44 include, but are not limited to, preferences indicating where a customer would like to receive media content (e.g. their television or their personal computer), and how a customer would like to view commercials (e.g. embedded, targeted or contextual). The customer can select advertising preferences and consider the tradeoff between advertising options and pricing for the downloading service. The customer 40 may update any of the customer preferences 44 by interacting with the automated assistant 36.

The automated assistant 32 interacts with the customer 40 to form customer search criteria 50 to assist in searching for specific media content. Examples of data elements in the customer search criteria 50 include, but are not limited to, a media element 52, a quantity element 54, a search topic element 56, a search source element 60, a search time element 62, and a product element 64. The media element 52 characterizes the media content, such as being either a television show, a sporting event, or an order for a product. If the media element 52 indicates an order for a product, the product element 64 identifies the product. The quantity element 54 indicates how many items (e.g. either media or products) are being ordered. The search topic element 56 indicates a general topic which describes the media content. The search source element 60 indicates a source which provides the media content, such as a particular television channel. The search time element 62 indicates a time period within which the media content was either broadcast or originally produced.

The data elements also include a delivery location element 66 and a delivery time element 68. The delivery location element 66 indicates where the items (e.g. either media or products) are to be delivered. For media content, the delivery location element 66 may be based on a customer's non-numeric identification of a particular location in a building. Examples of the building include, but are not limited to, a residence of the customer and a workplace of the customer.

The customer preferences 44 may comprise a table of non-numeric identifiers of different locations in a building associated with the customer 40. The non-numeric identifiers may include words which the customer uses in his/her common conversations to refer to locations in the building. For purposes of illustration and example, consider the building associated with the customer 40 being his/her place of residence, such as a house or an apartment. In this case, the customer preferences 44 may comprise a table including names of rooms in the residence.

The names of the rooms non-numerically identify locations of different media players in the residence. Each of the media players can receive media content via the telecommunication network 14. Examples of the media players include, but are not limited to, a video player such as a television (TV) with or without a set-top box, an audio player, and a personal computer (PC) having an MPEG decoder and an Internet connection.

The delivery time element 68 indicates when the items (e.g. either media or products) are to be delivered. For example, the customer 40 may place a video-on-demand order which comprises a delivery time indicating when he/she wants to the receive at least one video.

The automated assistant 32 may interact with the customer 40 in a question-and-answer session to elicit all of the information needed to form a customer request for downloading content to a particular delivery location at a particular delivery time. Upon receipt of a new or a pending customer request, the appropriate content and advertisements are retrieved from the library storage 20 and combined based on the customer preferences 44 to form media content items 70. The appropriate content is retrieved from the indexed content 16 and the appropriate advertisements are retrieved from the indexed advertisements 24 in the library storage 20.

A post-processor 72 processes the media content items 70 for transport based on the customer preferences 44. The post-processor 72 may encode the media content items 70 so that high quality content can be transported efficiently via the telecommunication network 14 to a customer's display device 74. For example, if the telecommunication network 14 comprises a digital subscriber line, the post-processor 72 can process an MPEG representation or another variable-bit-rate (VBR) representation of a video program into a representation that is closer to being constant-bit-rate (CBR). In one embodiment, the post-processor 72 determines a plurality of time intervals Tp and Tn within the VBR representation. The time intervals Tp are those in which a number of blocks of information per unit time is greater than a baseline value. The time intervals Tn are those in which a number of blocks of information per unit time is less than the baseline value. A post-processed representation of the image sequence is created in which some blocks of information Bp are removed from the time intervals Tp and interlaced with blocks of information Bn in the time intervals Tn to reduce a variation in a number of blocks of information per unit time between the time intervals Tp and Tn. Details of the algorithm are disclosed in “METHOD AND SYSTEM TO IMPROVE THE TRANSPORT OF COMPRESSED VIDEO DATA”, having application Ser. No. 09/942,260, filed Aug. 28, 2001, having attorney docket code T00351, which is hereby incorporated by reference into the present disclosure. This algorithm can be used to stream movies to the customer in real-time at a rate of about 1.5 Mb/sec.

The particular media content items 70 (e.g. at least one video item with selected commercials) in the order are transmitted by a video distribution element 76 via the telecommunication network 14 to the customer's particular delivery location at the particular delivery time. Examples of the telecommunication network 14 include, but are not limited to, digital subscriber lines, fiber optic lines, satellite, a cable television distribution system, and other broadband networks.

The customer 40 can view the particular media content items using the display device 74. Examples of the display device 74 include, but are not limited to, an Internet PC with an MPEG decoder, televisions and stereos with an appropriate set-top box, and other media playing and/or storing devices. The customer 40 can store the downloaded media content items in a digital video recorder (DVR) for later viewing using the display device 74. Thus, the customer 40 can either view the media content items while they are being downloaded, or can download the media content items to the DVR or another storage device for viewing at a later time.

A decoder 80 processes the incoming media data to form a signal that can be presented to the display device 74 and/or to a DVR. For example, when DSL is used as the transport mechanism, the decoder 80 may include a first decoder 82 to decode the near-CBR representation generated by the post-processor 72 into an MPEG representation or another VBR representation, and an MPEG decoder 84 or another VBR decoder to decode the MPEG or other VBR representation into a signal such as a display signal.

Although illustrated for a single customer, those having ordinary skill will recognize that the teachings herein apply to multiple customers at multiple locations. Each of the customers has his/her own access code and associated set of customer preferences.

Some of the indexed content 16 stored in the library storage 20 has an associated active/inactive indicator. Each indicator indicates whether its associated media content item is active or inactive for downloading to end viewers. Each media content item may have its own schedule of being active and inactive for downloading.

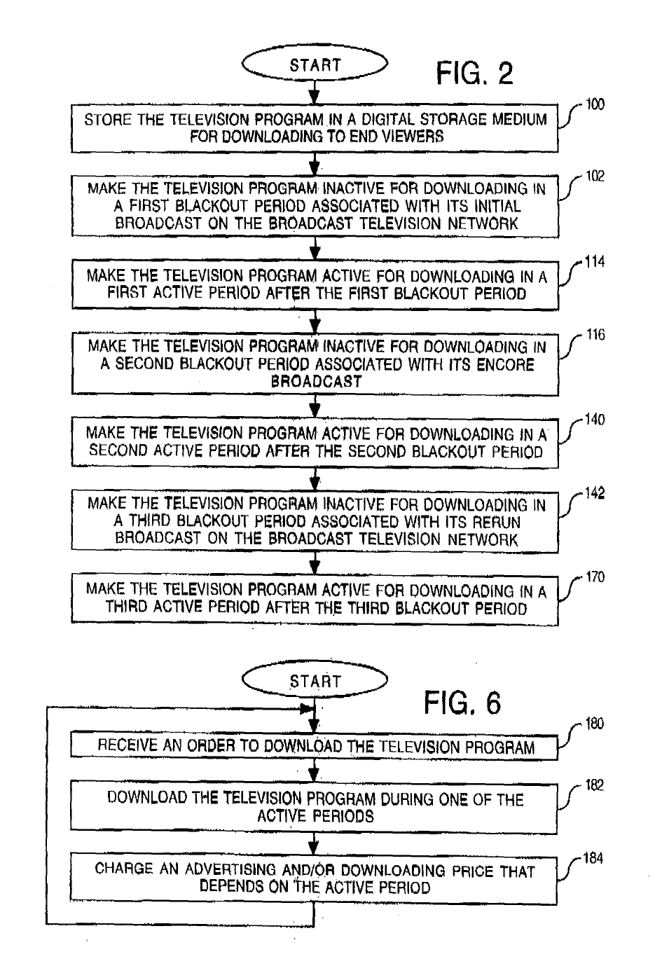

FIG. 2 is a flow chart of an embodiment of a method of making a television program or another media content item active and inactive for downloading. As indicated by block 100, the method comprises storing the television program in a digital storage medium for downloading to end viewers. With reference to FIG. 1, the television program is processed by the media processor 12 and stored in the indexed content 16 in the library storage 20.

The television program may be recorded and digitized from its initial broadcast on a broadcast television network. The broadcast television network may have over-the-air local affiliates to broadcast the television program to end viewers. Examples of broadcast television networks with over-the-air local affiliates include, but are not limited to, ABC, CBS, NBC, FOX, UPN and WB. Alternatively, the broadcast television network may be a non-local cable broadcast channel or a non-local direct broadcast satellite channel. Examples of non-local cable and direct broadcast satellite channels include, but are not limited to, A&E, ABC Family, AMC, BET, BRAVO, CNBC, CNN, Comedy Central, Court TV, E!, ESPN Classic, ESPN, ESPN2, Fox News Channel, Food Network, Fox Sports Net, FX, Game Show Network, The Golf Channel, HGTV, The History Channel, Lifetime, MSNBC, MTV, Nickelodeon, SCI-FI, SPEED, TBS, TCM, TLC, TNN, TNT, TVLAND, Cartoon Network, Discovery Channel, Animal Planet, VH-1, WGN Satellite (not the local WGN-TV), and USA. The term “non-local” is meant to exclude retransmission of local over-the-air affiliates on a cable television system or a direct broadcast satellite.

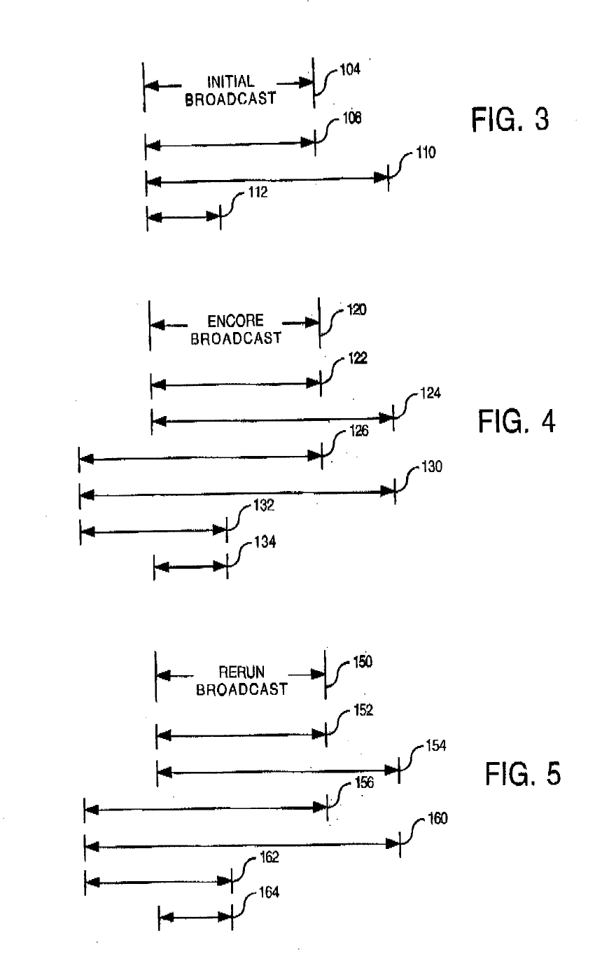

As indicated by block 102, the method comprises making the television program inactive for downloading in a first blackout period associated with its initial broadcast on the broadcast television network. FIG. 3 illustrates a time period 104 during which the television program is initially broadcast. Examples of the first blackout period include: a time period 106 that substantially spans the entire time period 104 and ends substantially at the end of the time period 104; a time period 110 that substantially spans the entire time period 104 and spans beyond the end of the time period 104; and a time period 112 that spans part of the time period 104.

As indicated by block 114 in FIG. 2, the method comprises making the television program active for downloading in a first active period after the first blackout period. Referring back to FIG. 3, the first active period may begin after either of the inactive time periods 106, 110, or 112. For the inactive time period 106, the first active period begins about at the end of the initial broadcast. For the inactive time period 110, the first active period begins some time (e.g. one hour, three hours, or one day) after the end of the initial broadcast. For the inactive time period 112, the first active period begins during the initial broadcast.

As indicated by block 116, the method comprises making the television program inactive for downloading in a second blackout period associated with its encore broadcast. In many cases, the initial broadcast is on a broadcast network having over-the-air local affiliates, while the encore broadcast is not on the over-the-air local affiliates but rather on a non-local cable broadcast channel or a non-local direct broadcast satellite channel. For example, the series “24” may have an initial broadcast on FOX and an encore broadcast on FX within a week after the initial broadcast. In other cases, the encore broadcast may occur on the broadcast network that provided the initial broadcast.

FIG. 4 illustrates a time period 120 of the encore broadcast of the television program. The second blackout period may span substantially all of the time period 120, such as: a time period 122 that begins substantially at the beginning of the time period 120, and ends substantially at the end of the time period 120; a time period 124 that begins substantially at the beginning of the time period 120 and spans beyond the end of the time period 120; a time period 126 that begins before at the beginning of the time period 120 and ends substantially at the end of the time period 120; and a time period 130 that begins before at the beginning of the time period 120 and ends after the end of the time period 120. Alternatively, the second blackout period may span part of the time period 120, such as: a time period 132 that begins before the beginning of the time period 120, and ends within the time period 120; and a time period 134 that begins substantially at the beginning of the time period 120, and ends within the time period 120.

As indicated by block 140 in FIG. 2, the method comprises making the television program active for downloading in a second active period after the second blackout period. Referring back to FIG. 4, the second active period may begin after either of the inactive time periods 122, 124, 126, 130, 132, or 134. For the inactive time periods 122 and 126, the second active period begins about at the end of the encore broadcast. For the inactive time periods 124 and 130, the second active period begins some time (e.g. one hour, three hours, or one day) after the end of the encore broadcast. For the inactive time periods 132 and 134, the second active period begins during the encore broadcast.

As indicated by block 142, the method optionally comprises making the television program inactive for downloading in a third blackout period associated with a rerun broadcast on the broadcast network. The rerun broadcast typically takes places one or more months after the initial broadcast. For example, the rerun broadcast of “24” may occur on FOX six months after its initial broadcast.

FIG. 5 illustrates a time period 150 of the rerun broadcast of the television program. The third blackout period may span substantially all of the time period 150, such as: a time period 152 that begins substantially at the beginning of the time period 150, and ends substantially at the end of the time period 150; a time period 154 that begins substantially at the beginning of the time period 150 and spans beyond the end of the time period 150; a time period 156 that begins before at the beginning of the time period 150 and ends substantially at the end of the time period 150; and a time period 160 that begins before at the beginning of the time period 150 and ends after the end of the time period 150. Alternatively, the third blackout period may span part of the time period 150, such as: a time period 162 that begins before the beginning of the time period 150, and ends within the time period 150; and a time period 164 that begins substantially at the beginning of the time period 150, and ends within the time period 150.

As indicated by block 170, the method comprises making the television program active for downloading in a third active period after the third blackout period. Referring back to FIG. 5, the third active period may begin after either of the inactive time periods 152, 154, 156, 160, 162, or 164. For the inactive time periods 152 and 156, the third active period begins about at the end of the rerun broadcast. For the inactive time periods 154 and 160, the third active period begins some time (e.g. one hour, three hours, or one day) after the end of the rerun broadcast. For the inactive time periods 162 and 164, the third active period begins during the rerun broadcast.

The above-described process is performed for multiple television programs from multiple broadcast networks. Other active/inactive states may be based on syndication of the television programs.

FIG. 6 is a flow chart of an embodiment of a method of downloading the television program. As indicated by block 180, the method comprises receiving an order to download the television program during any of the active periods. The order may be received at any time, including inactive periods, but its delivery time element 68 is limited to be within one of the active periods. The order is received by the automated assistant 32 as described with reference to FIG. 1.

As indicated by block 182, the method comprises downloading the television program during one of the active periods based on the order. Thus, the television program may be downloaded during either the first active period, the second active period, or the third active period. The television program is retrieved from the library storage 20, optionally combined with advertisements, processed, and distributed to the customer as described with reference to FIG. 1.

As indicated by block 184, the method optionally comprises charging an advertising and/or downloading price that depends on which active period the download is performed.

In summary, the system described herein is able to gather and understand customer tasks, search a content database through indexes to locate particular content items, and deliver the particular content items to a customer's desired location (e.g. a personal computer in the study or the family room TV set). The system may use more than one modality to interact with the customer, e.g. using audio over a telephone and visual over a personal computer. This is particularly important for long lists of information, previewing video files, and other audio/visual situations.

The system has the ability to collect and save customer preferences. The system is further able to automatically update the customer's history as to previously viewed/listed content. Customer search criteria may be captured and retained by the system.

The system can separate content from advertising. For example, a show such as Law & Order can be stored separately from embedded advertisements. The customer can choose how they want to view a particular show: either with embedded advertisements (having a low cost to the customer), without embedded advertisements (having a higher cost to the customer), or with targeted advertisements based on customer preferences (higher cost to the advertiser). In addition to being based on customer preference, the targeted advertisements may be based on the content they are currently viewing and the customer's location. The targeted form of advertising allows commercials to reach viewers at a desired time and in a desired context.

It will be apparent to those skilled in the art that the disclosed inventions may be modified in numerous ways and may assume many embodiments other than the preferred forms specifically set out and described herein. For example, a television program may be made active for downloading in a time period before its initial broadcast on a broadcast television network. Such a time period may be referred to as a “sneak preview” period. A subscriber may be charged a premium to view a sneak preview of a television program before its broadcast on the broadcast television network.

Accordingly, it is intended by the appended claims to cover all modifications which fall within the true spirit and scope of the present invention.

What is claimed is:

1. A method comprising:
storing a television program in a digital storage format for downloading to end viewers;
making the television program inactive for downloading in a first blackout period associated with its first broadcast on a broadcast television network;
making the television program inactive for downloading in a second blackout period associated with its second broadcast; and
making the television program active for downloading in a first active period between the first blackout period and the second blackout period.

2. The method of claim 1 further comprising:
making the television program active for downloading in a second active period after the second blackout period.

3. The method of claim 2 further comprising:
making the television program inactive for downloading in a third blackout period associated with its rerun broadcast on the broadcast television network.

4. The method of claim 1 further comprising:
receiving an order to download the television program during the first active period; and
downloading the television program during the first active period based on the order.

5. The method of claim 1 wherein the broadcast television network is to broadcast the television program on a plurality of over-the-air local affiliates.

6. The method of claim 5 wherein the second broadcast of the television program is not on the over-the-air local affiliates.

7. The method of claim 5 wherein the second broadcast is on the broadcast television network.

8. The method of claim 1 wherein the second broadcast is an encore broadcast of the television program on a non-local cable broadcast channel.

9. The method of claim 1 wherein the second broadcast is an encore broadcast of the television program on a non-local direct broadcast satellite channel.

10. The method of claim 1 wherein the first blackout period spans all of the first broadcast.

11. The method of claim 10 wherein the first blackout period spans beyond an end of the first broadcast.

12. The method of claim 1 wherein the second blackout period spans all of the second broadcast.

13. The method of claim 1 wherein the first blackout period spans a portion of the first broadcast, and the first active period begins during the first broadcast.

14. A method comprising:
storing a television program in a digital storage format for downloading to end viewers;
making the television program inactive for downloading in a first blackout period associated with its initial broadcast on a broadcast television network which broadcasts the television program on a plurality of over-the-air local affiliates;
making the television program inactive for downloading in a second blackout period associated with its encore broadcast on a non-local cable broadcast channel;
making the television program inactive for downloading in a third blackout period associated with its rerun broadcast on the broadcast television network;
making the television program active for downloading in a first active period between the first blackout period and the second blackout period;
making the television program active for downloading in a second active period between the second blackout period and the third blackout period;
receiving an order to download the television program; and
downloading the television program during either the first active period or the second active period based on the order.

15. A system comprising:
a digital storage medium to store a television program for downloading to end viewers, to make the television program inactive for downloading in a first blackout period associated with its first broadcast on a broadcast television network, to make the television program inactive for downloading in a second blackout period associated with its second broadcast, and to make the television program active for downloading in a first active period between the first blackout period and the second blackout period.

16. The system of claim 15 wherein the digital storage medium is further to make the television program active for downloading in a second active period after the second blackout period.

17. The system of claim 16 wherein the digital storage medium is further to make the television program inactive for downloading in a third blackout period associated with its rerun broadcast on the broadcast television network.

18. The system of claim 15 further comprising:
an automated assistant to receive an order to download the television program during the first active period; and
a video distribution element to download the television program during the first active period based on the order.

19. The system of claim 15 wherein the broadcast television network is to broadcast the television program on a plurality of over-the-air local affiliates.

20. The system of claim 19 wherein the second broadcast of the television program is not on the over-the-air local affiliates.

21. The system of claim 19 wherein the second broadcast is on the broadcast television network.

22. The system of claim 15 wherein the second broadcast is an encore broadcast of the television program on a non-local cable broadcast channel.

23. The system of claim 15 wherein the second broadcast is an encore broadcast of the television program on a non-local direct broadcast satellite channel.

24. The system of claim 15 wherein the first blackout period spans all of the first broadcast.

25. The system of claim 24 wherein the first blackout period spans beyond an end of the first broadcast.

26. The system of claim 15 wherein the second blackout period spans all of the second broadcast.

27. The system of claim 15 wherein the first blackout period spans a portion of the first broadcast, and the first active period begins during the first broadcast.
